(19) United States
(12) Patent Application Publication
(10) Pub. No.: US 2006/0048434 A1
(43) Pub. Date: Mar. 9, 2006

(54) Methods and systems for developing and deploying a realistic, virtual fishing experience which provides opportunities for learning to fish and instantaneous experience measurement

(76) Inventor: Robert J. Congel, Fayetteville, NY (US)

Correspondence Address: JLB Consulting;c/o PortfolioIP, P.O. Box 52050, Minneapolis, MN, 55402, US

(21) Appl. No.: 11/212,489

(22) Filed: Aug. 26, 2005

Related U.S. Application Data
(60) Provisional application No. 60/607,094, filed on Sep. 3, 2004.

(51) Int. Cl. A01K 97/00

(52) U.S. Cl. 43/4

(57) ABSTRACT

Methods and systems for simulating fishing, bringing together the ability of experts under relevant experiential conditions in a realistic virtual setting to provide an all inclusive, non-threatening learning experience. The invention enables cost effective testing of fishing equipment for efficacy under a wide variety of varying conditions. The invention further enables the instantaneous and continuous compilation, storage, display and analysis of data from this testing for a wide variety of uses.

### BACKGROUND

Learning to fish can be daunting because of issues including the infinite varieties of water, tackle, climate, venues, weather and types of fish.

Continuous testing of the efficacy of and satisfaction with specific types of fishing tackle and equipment—whether currently available commercially or as experimental prototypes—under multiple and varying conditions is not as a practical matter possible for most enthusiasts.

Simulators are known that can determine and provide accurate and realistic sensory and physical representation for essentially any human function.

### SUMMARY OF THE INVENTION

The present inventors have determined that it is desirable to provide expert coached, virtual, realistic experiences to teach fishing to beginners and enhance the expertise of current fishers as well as to test and instantaneously receive information on experimental new products for value and efficacy of use prior to production.

Further, these data can be instantly compiled, stored, displayed, or analyzed on a continuous basis for uses including market research, tournament results and new product development.

The present invention provides methods and systems for bringing together the ability of experts under relevant experiential conditions in a realistic virtual setting to provide an all inclusive, non-threatening learning experience.

Further, the invention provides an opportunity to cost effectively test experimental and currently available fishing equipment for efficacy under a wide variety of varying conditions. The invention further enables the instantaneous and continuous compilation, storage, display and analysis of data from this testing for a wide variety of uses.

### DETAILED DESCRIPTION OF THE INVENTION

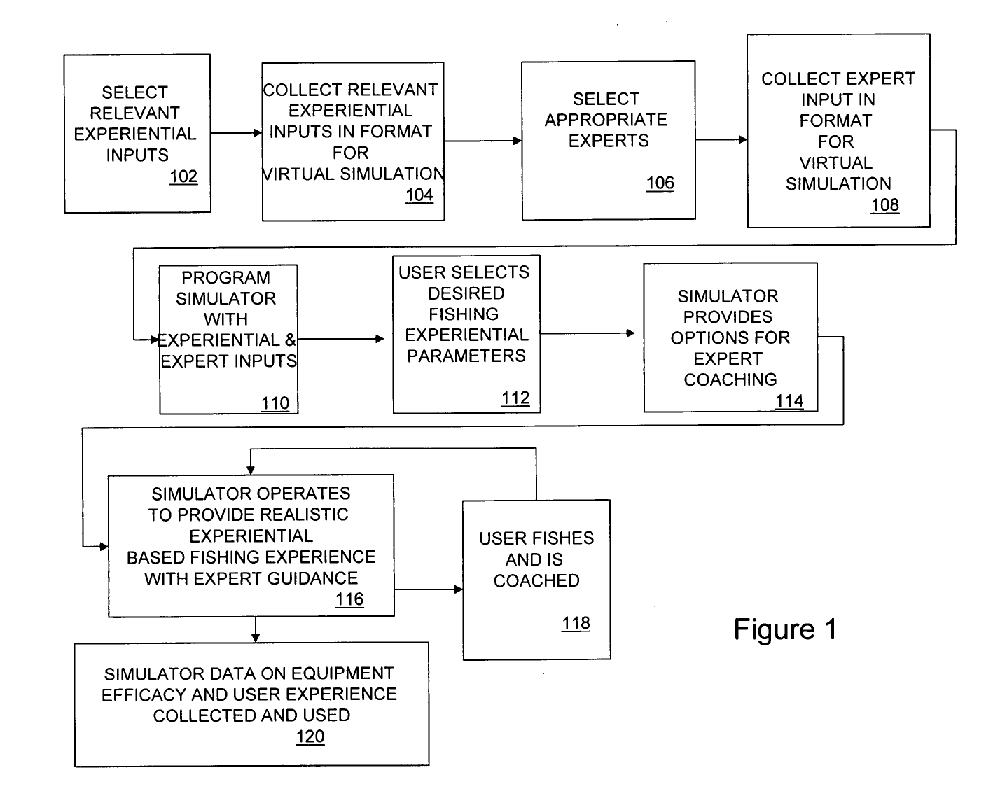

Objects, features and advantages of the invention will be apparent from a consideration of the detailed description of the invention when read in conjunction with the drawing FIG. 1.

With reference to FIG. 1, there is shown a process 100 for developing and deploying a realistic, virtual, educational fishing experience. This process can also collect, transmit and analyze data and information on user success, and equipment efficacy and user satisfaction instantly and/or store said data for later use.

### DETAILED DESCRIPTION OF THE INVENTION

With reference to FIG. 1, initially relevant experiential inputs including those for climate (including but not limited to temperature, wind conditions, cloud cover, precipitation); location (including but not limited to land or water, where type of craft can be specified); time of day; time of year; body of water; water conditions (including but not limited to conditions of calm, moving, turbulence and level, clarity, temperature, location); fish specie and size; equipment (including but not limited to rod, reel, lure, bait, line both in existence and purchasable currently and those that are experimental in nature); and clothing and gear are selected (step 102). The relevance of these inputs are determined based on the likelihood that they would be of interest to a new or experienced fisherman, for example who desires to learn and/or improve their fishing skills.

Once identified, the experiential data are collected in a format relevant to and able to be incorporated into visually, audibly and tactilely optimal fishing experiences (step 104) in the described embodiment within a simulator.

Once experiential data is collected, as a basis for a learning experience, experts are selected relevant to different types of fishing experiences (step 106), for example: the fish species desired to be virtually represented, the type and location of water to be fished, the type of equipment to be used, and others as will now be apparent to the reader.

Information on the fishing techniques, recommendations, practices, skills and other communicable expertise of the experts are obtained and recorded using methods relevant to virtual simulation and coaching (step 108). Different methods including the use of artificial intelligence program processes are known for collecting expert information and placing it within a simulator.

All data, including the experiential inputs and the expert information, are incorporated into a realistic simulator capable of delivering a total virtual experience to the user and to test both new and experimental fishing equipment for efficacy in real time (step 110).

To begin the simulation, the user selects the experiential conditions they wish to simulate (step 112). Conditions can include but are not limited to those as described above.

Following selection by the user of experiential conditions, desired fish species to be caught, and other information relevant to the desired experience of the user, the simulator recommends to the user a range of potential experts to coach the user through the simulation and learning experience (step 114).

The technique of the user can be compared in real time with those of the expert using the techniques of the virtual simulation (step 116). If desired, the simulator may also suggest, based upon the expert programming, tackle and equipment appropriate for the experiential conditions chosen by the user.

The user is coached in a realistic virtual environment for a duration of time, for example as chosen by the user or until a given outcome, also selectable by the user, is achieved. (step 118).

Concurrent with the learning experience of the user (step 116) data and information on the experience, including efficacy of the equipment and success of catching the fish of the specifications initially selected is recorded (step 120). These data can be used instantly, analyzed or stored and compiled for later use. Instant use of the data can include for posting to virtual tournament results.

There is thus provided methods and systems for enabling fisherman of all levels of expertise to learn and develop their skills in a safe, comfortable and secure environment. The invention provides the user with access to unique, valuable and specifically tailored expertise not typically otherwise available to a fisherman. The invention further provides for the collection of data directly pertinent to the success of a fisherman using different types of equipment in different conditions and in accordance with professional suggestions. Such data is of particular value to fishing equipment developers as well as professionals, guides and instructors.

What is claimed is:

1. Methods and systems for facilitation a virtual fishing experience and the collection of data therefrom, comprising:
collecting for use in a simulator real life experiential data relating to fishing conditions;
collecting for use in the simulator expert advice relating to fishing;
receiving from a user an identification of a desired fishing experience;
providing to the user options for the desired fishing experience including a selection of experts;
receiving from the user a selection from the options; and
initiating a simulation of the fishing experience including the desired fishing experience with the selected options.

2. The method further including:
the options including a selection of fishing equipment; and
the step of collecting data relating to the results of the simulation of the fishing experience for use in evaluating the fishing equipment.
